(19) United States
(12) Patent Application Publication
(10) Pub. No.: US 2026/0328020 A1
(43) Pub. Date: Oct. 22, 2026

(54) HANDLE WITH AXIAL LOCKING

(71) Applicant: IGOR VANJIN, FRIDOLFING (DE)

(72) Inventor: IGOR VANJIN, FRIDOLFING (DE)

(21) Appl. No.: 19/119,243

(22) PCT Filed: Mar. 28, 2023
(86) PCT No.: PCT/EP2023/058046

§ 371 Date: Apr. 8, 2025

(30) Foreign Application Priority Data
Oct. 10, 2022 (DE) 10 2022 126 215.4

(51) Int. Cl. E05B 13/00

(52) U.S. Cl. CPC E05B 13/002

(57) ABSTRACT

The invention relates to a door handle set, comprising a first handle formed as an outer handle, a base plate connected thereto having at least one locking element, and a polygon which can be brought into engagement with the base plate and outer handle and which has at least one latching pin. By moving the polygon in the axial direction, the latching pin interacts with the at least one locking element in such a way that, in a first position of the polygon, the outer handle is blocked for movement in a predetermined radial movement direction, and, in a second position of the polygon, is released for movement in a predetermined radial movement direction.

### FIELD

Disclosed is a handle that can be locked on one side, wherein the locking is achieved by means of axial displacement of an axially displaceable latching part.

### BACKGROUND

Handles are known from the prior art in which the entire handle (lever handle set) is displaced axially, e.g. from DE 20 2021 106 925 U1. It is disclosed there that both handles of the door handle set, together with a polygon and grub screws, form a connected, axially displaceable unit. The design is constructively complex and must be individually installed in each case.

### SUMMARY

The invention is based on the object of simplifying the design and installation of handle sets, as well as producing a more stable locking effect.

This object is achieved by the features of the independent claim. Advantageous embodiments are the subject matter of the dependent claims.

The invention relates to a door handle set, comprising a first handle formed as an outer handle, a base plate connected thereto having at least one locking element, and a polygon which can be brought into engagement with the base plate and outer handle and which has at least one latching pin. By moving the polygon in the axial direction, the latching pin interacts with the at least one locking element in such a way that, in a first position of the polygon, the outer handle is blocked for movement in a predetermined radial movement direction, and, in a second position of the polygon, is released for movement in a predetermined radial movement direction.

It is further provided that the polygon has two latching pins opposite one another and that two locking elements are provided.

It is further provided that in an area of the outer handle, in which the polygon engages, there is an elongated hole in the outer handle and a threaded hole in the polygon in the area of the elongated hole, wherein a screw is further provided, which is screwed through the elongated hole into the threaded hole.

It is further provided that at least one hole is provided in an area of the outer handle in which the polygon engages, and at least one latching groove is provided in the area of the polygon at which the at least one hole is provided for each position of the polygon, and wherein a ball latch is provided for each hole, which is arranged in such a way that it latches into the at least one latching groove depending on the position of the polygon.

It is further provided that the door handle set also has an inner handle that can be engaged with an area of the polygon opposite the outer handle in such a way that it is operatively connected to it and can actuate the polygon in the radial direction in order to move the polygon to the first position and to the second position.

It is further provided that a blocking element projecting from the base plate is provided, that is arranged in such a way that the movement of the at least one latching pin is limited in the radial direction and against the predetermined radial movement direction.

Furthermore, the door handle set is also designed to have two domes that project out of the base plate and face one another, as well as two offset supporting domes that are offset to the domes, inserted into threaded holes in the base plate and project out of it, facing one another.

It is further provided that the door handle set also has at least one locking indicator arranged on a handle, which is or is not visible depending on the position of the polygon, and which is either provided between the area of the handle facing a door panel and a rosette and is formed as a colored layer, or is provided on a visible side of the handle, wherein the handle has a hole in an area above the polygon, and wherein an indicator element is mounted on the polygon in the area of the hole, which indicator element pushes an indicator into or out of the area of the opening of the hole by moving the polygon in the axial direction.

It is further provided that the base plate, outer handle and polygon are connected to one another in a form-fitting manner.

Further features and advantages of the invention will become apparent from the following description of exemplary embodiments of the invention, with reference to the figures in the drawings illustrating details thereof, and from the claims. The individual features can be realized individually or in any combination in a variant of the invention.

Preferred embodiments of the invention are explained in more detail below, with reference to the appended drawings.

### BRIEF DESCRIPTION OF THE DRAWINGS

FIG. 1 shows a slope view/section view of a complete handle set in a non-actuated state according to an embodiment of the present invention.

FIG. 2 shows a slope view of the handle set shown in FIG. 1.

FIG. 3 shows a slope section view of the handle set shown in FIG. 1.

FIG. 4 shows a slope view of the handle set shown in FIG. 1 in the actuated state according to an embodiment of the present invention.

FIG. 5 shows a slope section view of the handle set shown in FIG. 4.

FIG. 6 shows a magnified view of the area around the base plate in FIG. 2.

FIG. 7 shows a magnified view of the area around the base plate in FIG. 4.

FIG. 8 shows a slope view of a complete handle set in the locked state according to an embodiment of the present invention.

FIG. 9 shows a slope section view of the handle set shown in FIG. 1.

FIG. 10 shows a magnified view of the area around the base plate in FIG. 8.

FIG. 11 shows an enlarged view of a unit consisting of a base plate, a polygon and an outer handle 11 in an unlocked state according to a further embodiment of the present invention.

FIG. 12 shows an enlarged view of a unit consisting of a base plate, a polygon and an outer handle 11 in the locked state according to a further embodiment of the present invention.

### DETAILED DESCRIPTION

In the following figure descriptions, the same elements or functions are provided with the same reference signs.

Handle sets 1 for operating doors, for example, are well known. They consist of two handles 10, 11 arranged on either side of a door, or more precisely the door panel, which are mechanically connected to one another by a polygon 4. The polygon 4 is advantageous as a square. When one of the handles is operated, a latch in the lock provided in the door panel is activated and the door panel is released (opening the door). Traditionally, a bolt is also provided below the latch to lock the door. This can be operated in different ways, for example by using a cylinder that can be operated by key or electronically or by a rotary knob, which is installed in the door panel below the handle. In any case, when locked, the bolt prevents the door from being opened.

In some applications, however, it is not necessary to provide a door that can be locked with a bolt. For example, a simpler locking mechanism may be sufficient in the interior of a flat, e.g. in the bedroom or children's room, or in working spaces such as offices or home offices, or in toilets, etc., in particular to allow privacy. In these cases, it is not necessary to be able to lock and unlock the door from both sides at all times. To provide a suitable solution for this application, the following handle 11 and a door handle set 1 with the handle 11 and the corresponding counterpart (handle 10) are proposed.

In all the following described embodiments, the handle 11 is provided on the outside of the door and is referred to in the following as the outer handle 11. The outer handle 11 is not movable and is attached to the door panel in a pre-assembled state. In this case, base plate 2 and outer handle 11 are already firmly (but detachably) engaged with one another, so that only the polygon 4, which is advantageously connected to a handle 10 formed as an inner handle 10, needs to be inserted from the other side of the door in a floating manner to complete the door handle set 1.

In all embodiments, the locking is achieved by means of at least one latching pin 40 of the polygon 4 on the base plate 2 (mounted on the door panel) of the outer handle 11 when the polygon 4 is operated on the opposite side, i.e. the inside of the door, i.e. is axially displaced. This can be done, for example, with an inner handle 10 mounted on the polygon 4. Thus, an axial displacement of the inner handle 10 on the inside of the door causes a radial locking of the outer handle 11 on the outside of the door.

The fixedly mounted unit consisting of base plate 2, outer handle 11 fixed to it and the polygon 4 (latching pin 40) enables a form-fitting locking/blocking through all three components. When not locked/blocked, the components outer handle 11 and polygonal 4 (latching pin 40) move together as a unit in a radial direction.

The polygon 4, together with the outer handle 11 and the base plate 2, forms a form fitting unit. The inner handle 10 does not substantially contribute to the invention, since the polygon 4 can also be operated manually by moving it in the axial direction X. However, an inner handle 10 is usually provided to complete the door handle set 1.

The two handles (inner handle 10 and outer handle 11) can be the same or different, e.g. as a latch, knob or in some other way.

The individual components of the door handle set and how they work are described in detail below.

As already mentioned, outer handle 11 and base plate 2 are firmly connected to one another (axially fixed, radially movable) in all embodiments to form a pre-assembled unit. This is done, for example, by the outer handle 11 having a ball-and-socket joint and a bayonet lock provided in a collar 110 (for the receptacle/connection with the base plate 2), by means of which the base plate 2 is applied and mounted with a form fit with a corresponding collar 24 (formed out of the base plate 2). In the center of collars 110, 24, there is a passage for receiving the polygon 4, which is used to engage the polygon 4 with the outer handle 11 and produce the operative connection. The mounting of the polygon 4 on the outer handle 11 is done as known from the prior art, e.g. via a screw connection, which can also serve as an emergency release 3.

The polygon 4, which is inserted into and connected to the fixedly (but detachably) connected components of the outer handle 11 and the associated base plate 2, has at least one latching pin 40 that protrudes orthogonally (to X). Advantageously, two latching pins 40 are provided, located opposite one another at 180 degrees around the body of the polygon 4. The latching pins 40 are advantageously formed in one piece with the polygon 4. The following description always refers to two latching pins 40. Advantageously, a square is provided as the polygon 4.

The latching pins 40 are provided on the side of the outer handle 11 and are operatively connected to both the outer handle 11 and the base plate 2. To do this, the collars of the base plate 2 and the outer handle 11 have superimposed grooves in the zero position of the outer handle 11 to form the receptacle for the latching pins 40. Zero position means that none of the handles 10, 11 are operated.

When not locked (first position of the polygon 4), the latching pins 40 are freely moved when one of the handles 10, 11 is operated and are not blocked/locked. In the locked state (second position of the polygon 4), a part of the base plate 2, in particular a part of its collar 24, serves as a locking mechanism, on which the latching pin 40 is blocked with as little play as possible (locking element 20 and the blocking element 23 described below block the latching pin 40 in the radial direction).

The basic principle is that the latching pins 40 of the polygon 4 are released by pushing or pulling them in the axial direction X, or that a radial movement in the predetermined movement direction (to open the door) is prevented by hitting a locking element 20 of the base plate 2, thus producing a locked state. The locking element 20 and the latching pins 40 are advantageously formed as perpendicular surfaces that rest against one another in the locked state. This ensures a large surface area and secure locking.

In all embodiments, a blocking element 23 of the base plate 2 arranged opposite to the movement direction also prevents the handles 10, 11 from being moved in the opposite direction to the actuation direction in both the locked and the unlocked state. The blocking element 23 is advantageously part of the collar 24 of the base plate 2.

Two embodiments are described below to provide the locking mechanism.

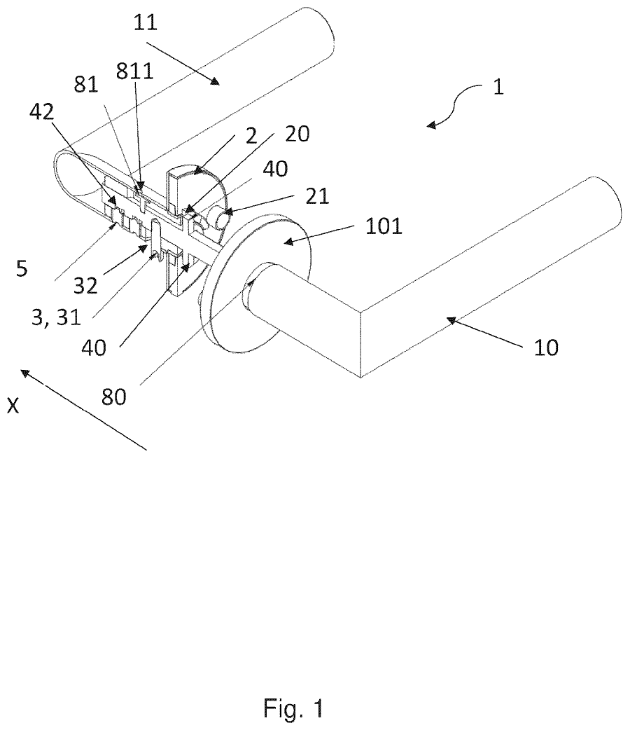

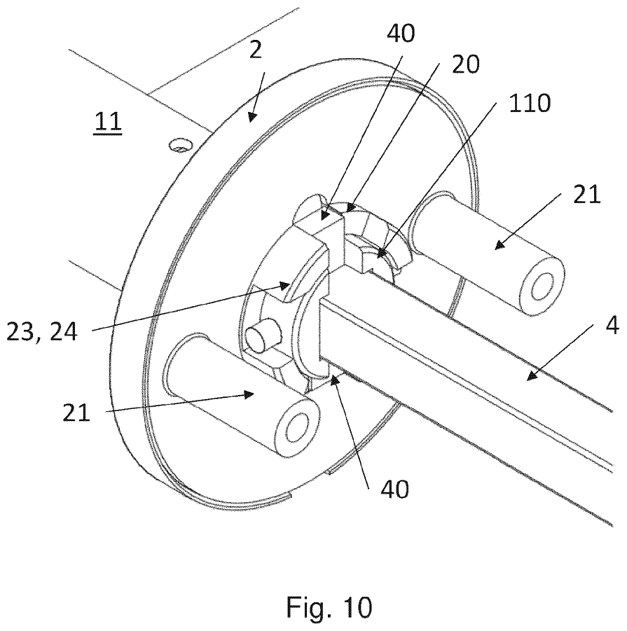

A first embodiment is shown in FIGS. 1 through 10. In this embodiment, the locking is done by pressing the polygon 4 in the axial direction (direction of the outer handle 11).

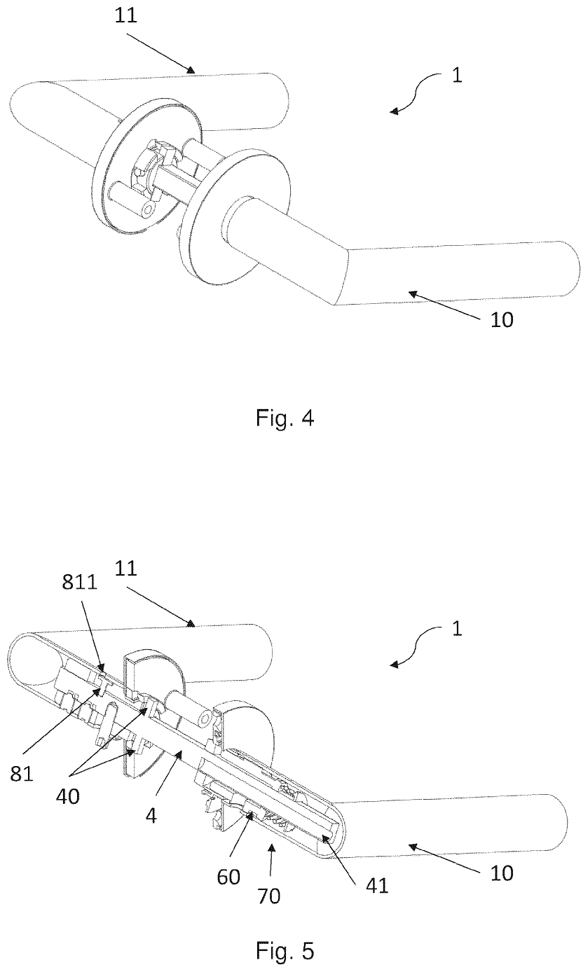

FIGS. 1, 2, 3 and 6 show a condition of the handle set in the unlocked, non-operational state. FIGS. 4, 5 and 7 show a state of the handle set in the unlocked, actuated state, i.e. the outer handle 11 is moved in the (radial) movement direction. Before blocking, i.e. in a freely movable state, the latching pin(s) 40 glide within the actuation radius during actuation.

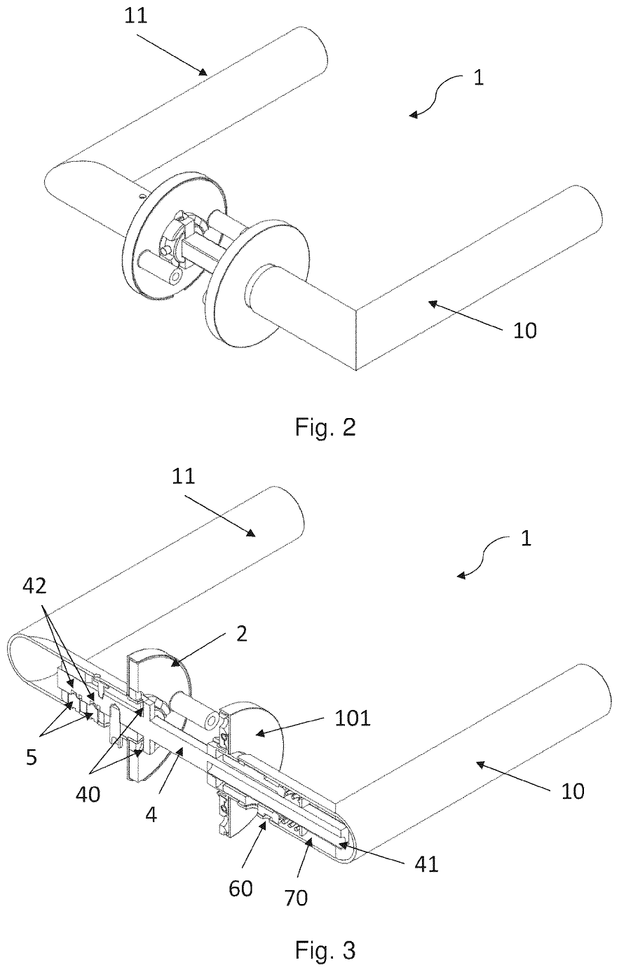

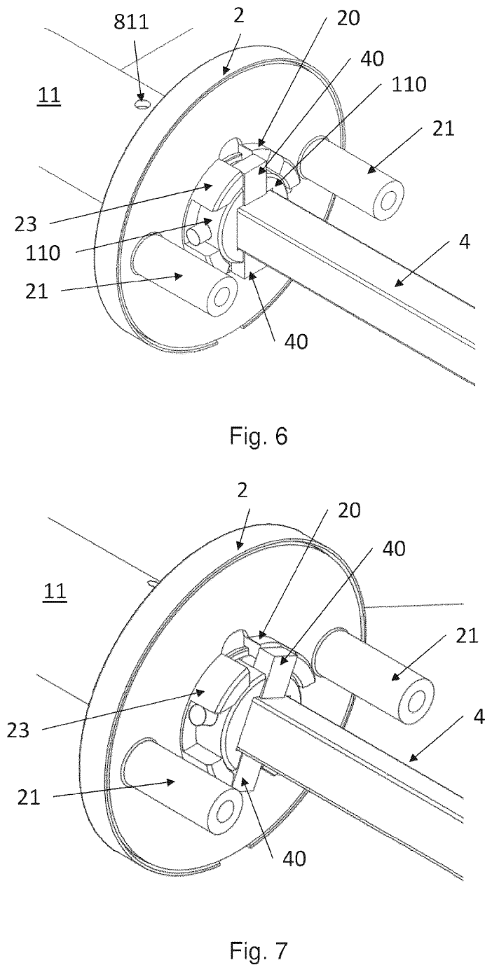

When freely movable (not locked), the latching pins 40 can move radially freely in the specified direction and distance (as is usual for handles 10, 11). FIG. 1 shows a slope view of a complete handle set, i.e. with both handles 10, 11, in the mounted state, but without the door panel in between, in the non-activated state. The outer handle 11 is shown in cross-section. FIGS. 2 and 4 each show a slope view of a complete handle set. FIGS. 3 and 5 each show a slope cut view of a complete handle set. FIGS. 6 and 7 show an enlarged view of the area of base plate 2 in FIGS. 2 and 4, respectively. Here it can be clearly seen that the latching pins 40 are located above the locking element 20 and are thus free to move in an actuation direction. The blocking element 23 is provided in the opposite actuation direction.

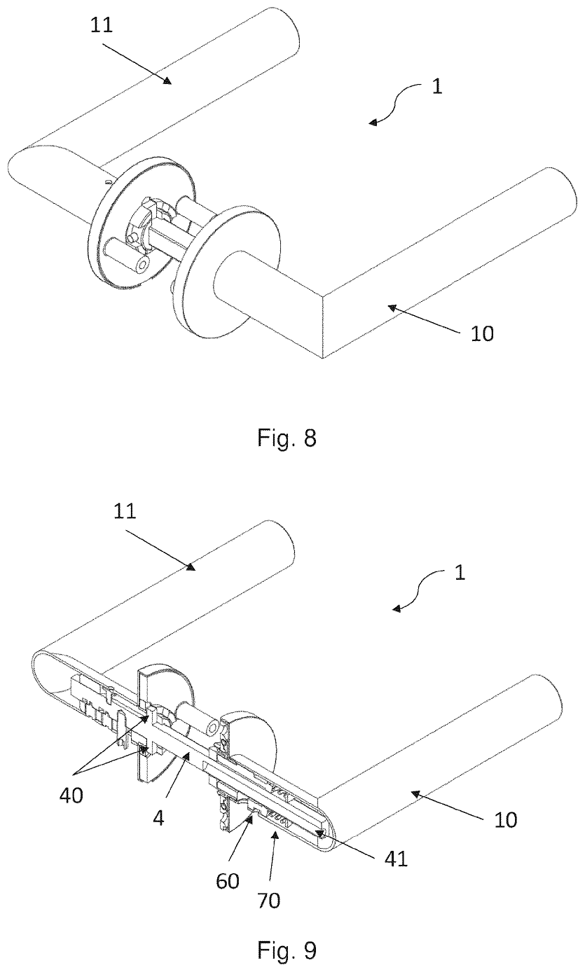

Locking/unlocking takes place in the zero state by means of axial pressure from the inside on the handle 10 on the inside of the door, i.e. the inner handle 10. This leads to the latching pins 40 engaging between the blocking element 23 and the locking element 20 of the base plate 2, as shown in FIGS. 8, 9 and 10. The locking element 20 serves as a stop for the latching pin(s) 40 in the radial movement direction. Radial movement of the lever handle (handles 10 and 11) is then no longer possible. The lock is then released again by pulling on the handle 10 on the inside of the door panel.

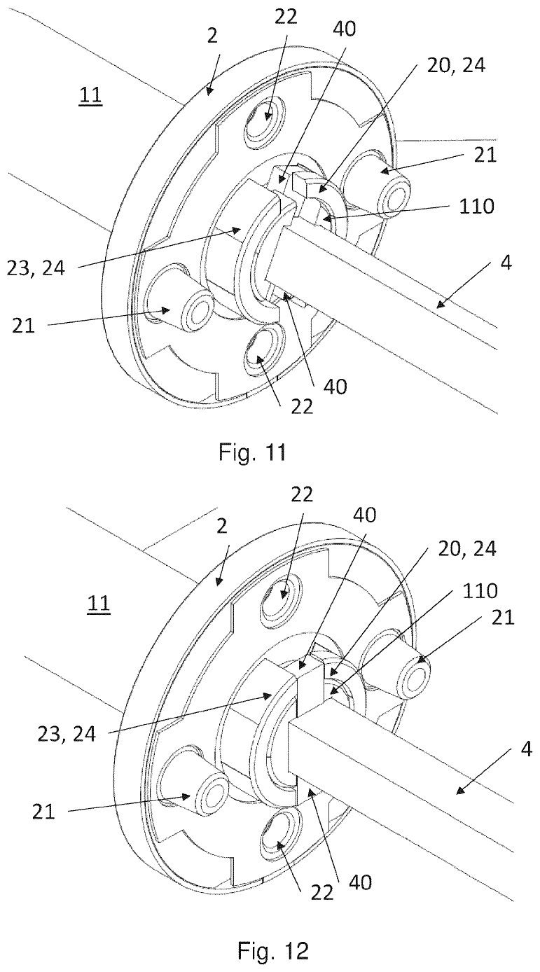

A second, preferred embodiment is shown in FIGS. 11 and 12. In this embodiment, locking is achieved by pulling the polygon 4 towards the inside of the door, i.e. away from the door panel. In this embodiment, locking is therefore carried out by pulling (in axial direction X) the polygon 4 on the inside of the door, in particular by means of the inner handle 10, if present. In this embodiment, the collar 24 of the base plate 2 has an undercut in the movement direction of the operation and directly adjacent to the groove. This leaves an opening (groove) between the base plate 2 and the upper edge of the collar 24, in which the latching pin 40 is guided in the unlocked state. The opening has a height that corresponds to the height of the latching pin 40 and is advantageously only slightly higher in order to ensure ease of movement. In addition, their length (in the movement direction) is limited to allow limitation of the radial movement of the handles 10, 11.

When locked, the latching pin 40 is held in the groove of the collar 24 of the base plate 2. The side of the groove that acts in the movement direction serves as the locking element 20 and thus as a stop for the latching pin 40. The other side of the groove serves as a blocking element 23.

This embodiment has the advantage that no accidental locking can occur when the door is closed from the inside, as the movement direction of the locking mechanism is opposite to the direction in which the door is closed.

In all embodiments, as is common in the prior art, two opposing domes 21 are provided on the base plate 2, which are inserted into passages in the door and in which screws of the mounting plate 101 of the handle 10 on the inside of the door can be screwed. These domes 21 are at least as high as the collar 110 of the outer handle 11 and the collar 24 of the base plate 2, but advantageously slightly higher. In addition to the two domes 21, additional support domes, preferably offset by 90 degrees to the domes 21 (located on the same circumference) and also located opposite one another, can optionally be provided. These can, for example, be screwed into prepared threaded openings 22 of the base plate 2, as indicated in FIGS. 11 and 12, so that they serve as an additional component. Their height corresponds favorably to the height of the dome 21. Just as for the domes 21, corresponding holes must be provided in the door panel, although these do not have to be passages through the door panel, as the support domes only need to provide support for forces acting on the outer handle 11. These support domes are therefore an additional anti-twist device. However, they also serve to distribute the forces acting on the outer handle 11 more evenly, especially when trying to operate the outer handle 11 with greater force when it is locked.

Furthermore, a combination of screw 31 and elongated hole 32 is provided in all embodiments in the area of outer handle 11, in which the polygon 4 engages, which also serves as an emergency release 3. The combination is advantageously arranged on an underside of the outer handle 11, which is not a visible side. An elongated hole 32 is provided in the outer handle 11 in axial direction X, into which a screw 31 is inserted, which engages with the polygon 4, i.e. is screwed in there. The elongated hole 32 serves to ensure that the screw 31 can also move during axial movement of the polygon 4 and thus does not form a lock. At the same time, the elongated hole 32 serves as a movement limiter in axial direction X for the polygon 4. Elongated hole 32 and screw 31 are matched to one another in such a way that there is as little play as possible, but the movement in axial direction X is still smooth. For this purpose, the diameter of the elongated hole 32 should be slightly larger than that of the screw 31. In one embodiment, the screw 31 protrudes minimally from the elongated hole 32. If an emergency release 3 is required, this screw 31 can be used to move the polygon 4 out of the locking position into the freely movable position by pushing it axially. No special tools or screwdrivers are required. The screw 31 can be moved with any object, e.g. a key, a coffee spoon, a fingernail, etc., as long as the necessary force can be applied.

Furthermore, in all embodiments, at least one hole for the receptacle of a ball latch 5 can be provided in the area of the outer handle 11 in which the polygon 4 engages. This is inserted into a hole in the outer handle 11 and engages with its ball end audibly for a user in a corresponding latching groove 42 when the polygon 4 is operated, i.e. when it is displaced in axial direction X. The at least one ball latch 5 is advantageously arranged on an underside of the outer handle 11, which is not a visible side.

One or more locking indicators can be provided in all embodiments. A locking indicator can be provided on the inside of the door to show the user that the door is locked or unlocked. In addition, a locking indicator can also be provided on the outside to show a user looking at the door from the outside whether the door is locked or unlocked.

The locking indicator, i.e. the indicator of the opening or closing state, may for example not be located on or at the handle 10, 11, but on or as a layer 80 behind the rosette or oriented in the direction of a door panel, as shown in FIG. 1 as representative of all other embodiments in the area of the inner handle 10. In the area between the door panel, more precisely the rosette, and the handle 10, 11, for example, a colored marking is provided.

The locking indicator, i.e. the indicator of the opening or closing state, can, for example, be attached to or on the handle 10, 11, as shown in FIG. 1 as a representative of all embodiments in the area of the outer handle 11. Here, on the upper side of the outer handle 11, i.e. on the visible side, a viewing window 811 is provided as a hole in an area above the polygon 4. An indicator element 81 is provided in this area, which is colored, for example. As soon as the polygon 4 is moved, this indicator element 81 is displaced and the “open” or “locked” indicator (e.g. color) appears in the viewing area of the viewing window 811. Different embodiments are conceivable in which a colored indicator appears in both the locked and unlocked states or only in one of the states.

In order to obtain a complete door handle set 1 and to be able to operate the polygon 4 easily, two handles 10, 11 are usually provided, one of which is provided on the inside of the door (inner handle 10) and the other on the outside of the door (outer handle 11). The two handles 10, 11 are operatively connected via the polygon 4, as already described. Substantially any inner handle 10 can be used as the inner handle 10 for operating the proposed locking device, as it only serves to axially displace the polygon 4. The locking mechanism is located in the area of the outer handle 11, so that no changes to the inner handle 10 are necessary. The grub screw known from the prior art, which is screwed into a recess 60 in the inner handle 10, as shown for example in FIGS. 3, 5 and 9, in order to connect the latter to the polygon 4 and to move the latter in one direction (away from the door), is also used in accordance with the invention to produce the operative connection between the inner handle 10 and the polygon 4. It may be provided that the polygon 4 has a bore 41 in its interior in an outer area of it, as also shown by way of example in FIGS. 3, 5 and 9, which is formed in such a way that the inner wall of the polygon 4 that is created thereby is thinner in the area in which the grub screw is screwed in. This means that the grub screw can even penetrate through the inner wall and form a better connection with the polygon 4. In addition, a self-locking lock 70 can be provided, which locks the handle 10 in one direction (against being pulled out of the polygon 4). This self-locking lock 70 is already known and will not be described further.

It is therefore proposed to lock a door on the outer handle 11 by actuating the inner handle 10. This means that a separate bolt is no longer required, so that the door handle set consists of just one unit. The door handle set is used in areas where a certain degree of privacy is desired, as already described at the beginning.

It is therefore required that the lever handle can be moved axially on the inside as a connected unit with the square, in order to then lock on the outside—without an additional lever, knob or anything else. The door handle itself is used as an actuating element. Blocking/locking the outside makes sense because the pressure in the locked state is mainly on the outside—the prior art locks on the inside, where nobody wants to get in. This further increases the leverage effect on the locking mechanism. Furthermore, in contrast to the prior art, the locking mechanism, which is part of the square, has a double effect, i.e. both at the top and at the bottom: i.e. by at least two locking elements, wherein more locking elements are conceivable. The area of the locking elements (latching pin 40) that block is doubled, balanced and ensures permanent, reliable locking and secure function.

The known systems all have square pins that are heavily weakened by holes and grooves. This is highly complicated to produce—and therefore fragile and almost impossible to manufacture reliably in series, and then highly complicated to mount on the door and also to adjust door thicknesses. The proposed square remains full and solid throughout, especially where statics are required. In contrast to DE 20 2021 106 925 U1, the lever handle is no longer moved on the outside, but is a firmly connected unit with all other external components. In DE 20 2021 106 925 U1, the displacement would have had to move the entire handle unit through many different elements and at the same time many assembly errors would have had to be expected, which would have impaired the function. Inaccurate assembly, errors etc. are eliminated by the fact that the outside is delivered completely pre-assembled and there are no more “unknowns”.

Door thicknesses are easily covered as with normal fittings. This pre-assembly makes installation very quick and easy, even for non-professionals. A wide range of door thicknesses can also be covered and there is no dependence on the lock seat or other on-site requirements. Apart from the “Occupied” indicator on the outside and the “Open” indicator on the inside, the fittings are visually unchanged and fit perfectly into the overall picture. Optionally, an emergency release (3) can be fitted on the outside.

The embodiment and advantages of the invention are further noted:
the unit to be moved only becomes a unit after assembly by clamping and screwing it together
this unit takes care of all the prescribed requirements (emergency release, open-locked indicator, locking, unlocking, adjusting operator forces, . . . )
the locking at the top and bottom, in addition to the secure locking, also has the task of centering the forces when trying to open when locked
operator forces can be infinitely adjusted using the external thrust pieces
the existing door handle is used as a locking control and does not require any additional buttons or slides to lock the door
cannot be locked or unlocked from the outside unintentionally (only with the help of an everyday object (coin, pin, key, knife, fork . . . ) through the emergency release
extremely small installation space required in the door and in the rosette
extremely simple and cost-effective production (few parts and very easy to manufacture)

The following features are also claimed:
Door handle set that can be operated from the inside and locked from the outside
Axial movement of the assembly/unit
No passages (bores or grooves from the inside to the outside) in the square/static/stability (important for higher usage category certifications)
Locking/latching centric and not eccentric (distribution of forces)
No adjustment for different door thicknesses or lock positions

The invention is based, among other things, on the following performance requirements, which also describe its advantages:
1. Installation situation:
Conventional interior doors with lock 8/8.5 mm follower. Door thicknesses 38-45, rebated and butt-jointed. Door thicknesses must be covered with only one pin. Maximum installation space in the door diameter 22×7 mm better 5 mm.
2. Assembly:
Assembly must not be a challenge for the no-professional; assembly errors must be ruled out at the design stage. (deliver pre-assembled in the factory if possible)
3. Installation space and optics:
Installation space for 5 mm thick rosette incl. overclip must be sufficient. Every known rosette diameter and every known rosette thickness over 5 mm must be feasible. Optics like the current fittings. The red/white indicator must be clearly visible on the handle. Not the front head.
4. The lock can be released by blocking the radial movement as well as by disengaging the square on the outside. The control from the inside after closing must provide reliable feedback on the closed condition.
5. No small or very small parts.
6. The design must be easy and intuitive to use and provide maximum stability and safety. The closing and opening process must provide clear feedback. A clicking or resting sensation.
7. When locked, the latch must not move inwards more than 0.5 mm when an attempt is made to operate it. Ideally, you can consider locking and disengaging the clutch at the same time.
8. Operator forces must be determined. Possible occasional use of force included.
9. Unintentional locking or unlocking must be ruled out. Just like manipulating from the outside.
10. It must be possible to operate the emergency release with as little obstruction as possible using an everyday object. However, it must not be freely and visibly accessible. A certain “inhibition of play” must be introduced here.
11. EN 1906 user category class 3 minimum, class 4 without class 1 is to be aimed for.
12. The blockage must take place on the outside where the greatest pressure is exerted. Not like at Griffwerk inside where the operator only checks whether the door is locked.
13. All prior art complaints known by our customers and identified by us must be completely cured.
14. M4 max. M5 screw connection.
15. Button solutions must be feasible. Fixed as well as rotatable.
16. No weakening of the square due to milling or drilling
17. Backlash-free actuation in unlocked state (user class 3 min. 200,000 cycles).

### LIST OF REFERENCE NUMBERS

1 door handle set
10 handle inside, inner handle
101 mounting plate from 10
11 handle outside, outer handle
110 collar from 11
2 base plate
20 locking element
21 dome
22 threaded openings
23 blocking element
24 collar from 2
3 emergency release
31 screw
32 elongated hole
4 polygon
40 latching pin
41 bore
5 ball latch in 11
60 recess for grub screw
70 self-locking lock
X axial direction
80 locking indicator, visible range in 10
81 indicator element
811 viewing window/hole for indicator

1. A door handle set having a first handle formed as an outer handle (11), a base plate (2) connected thereto with at least one locking element (20), and a polygon (4) engageable with the base plate (2) and the outer handle (11) and having at least one latching pin (40), wherein the latching pin (40) interacts with the at least one locking element (20) by moving the polygon (4) in the axial direction (X) in such a way that the outer handle (11) is blocked for movement in a predetermined radial movement direction in a first position of the polygon (4) and is released for movement in a predetermined radial movement direction in a second position of the polygon (4).

2. The door handle set according to claim 1, wherein the polygon (4) has two latching pins (40) opposite one another, and wherein two locking elements (20) are provided.

3. The door handle set according to claim 1, wherein an elongated hole (32) is provided in the outer handle (11) in an area of the outer handle (11) in which the polygon (4) engages, and a threaded hole is provided in the polygon (4) in the area of the elongated hole (32), wherein further a screw (31) is provided which is screwed through the elongated hole (32) into the threaded hole.

4. The door handle set according to claim 1, wherein at least one hole is provided in an area of the outer handle (11) in which the polygon (4) engages, and in the area of the polygon (4) in which the at least one hole is provided, at least one latching groove (42) is provided for each position of the polygon (4), and wherein a ball latch (5) is provided for each hole, which is arranged in such a way that it engages in the at least one latching groove (42) depending on the position of the polygon (4).

5. The door handle set according to claim 1, further having an inner handle (10) which can be brought into engagement with an area of the polygon (4) opposite the outer handle (11) in such a way that it is operatively connected thereto and can actuate the polygon (4) in the radial direction (X) in order to bring the polygon (4) into the first position and into the second position.

6. The door handle set according to claim 1, wherein a blocking element (23) projecting from the base plate (2) is provided, which is arranged in such a way that the movement of the at least one latching pin (40) in the radial direction (X) and against the predetermined radial movement direction is thereby limited.

7. The door handle set according to claim 1, further having two opposing domes (21) projecting from the base plate (2), and two supporting domes which are offset relative to the domes (21), are inserted into threaded holes (22) in the base plate (2) and project therefrom, and opposing one another.

8. The door handle set according to claim 1, further having at least one locking indicator (80, 81) arranged on a handle (10, 11), which is visible or not visible depending on the position of the polygon (4), and which is
either provided between the area of the handle (10, 11) facing a door panel and a rosette and formed as a colored layer (8), or
provided on a visible side of the handle (10, 11), wherein the handle (10, 11) has a hole in an area above the polygon (4), and wherein an indicator element (81) is mounted on the polygon (4) in the area of the hole, which by moving the polygon (4) in the axial direction (X) slides an indicator into the area of the opening of the hole or out of the area of the opening of the hole.

9. The door handle set according to claim 1, wherein the base plate (2), outer handle (11) and polygon (4) are connected to one another in a form-fitting manner.

10. The door handle set according to claim 5, wherein inner handle (10) and outer handle (11) are formed in the same manner.

11. The door handle set according to claim 5, wherein inner handle (10) and outer handle (11) are formed as latch, as knob or as fixed or rotatable knob.
